(19) United States
(12) Patent Application Publication
(10) Pub. No.: US 2009/0056098 A1
(43) Pub. Date: Mar. 5, 2009

(54) Planar Construction Methods for Assembly of Optical Systems

(76) Inventor: Jonathan Payne, Acton (AU)

Correspondence Address: MILLER, MATTHIAS & HULL, ONE NORTH FRANKLIN STREET, SUITE 2350, CHICAGO, IL, 60606, US

(21) Appl. No.: 12/201,126

(22) Filed: Aug. 29, 2008

Related U.S. Application Data
(60) Provisional application No. 60/968,794, filed on Aug. 29, 2007.
(60) Provisional application No. 60/969,564, filed on Aug. 31, 2007.

(51) Int. Cl. B23P 11/00

(52) U.S. Cl. 29/428

(57) ABSTRACT

This disclosure relates to methods for assembling optical systems. One disclosed method includes: providing a substrate; providing a plurality of optical elements; arranging and selectively retaining the optical elements in a predetermined configuration; and applying the plurality of optical elements in the predetermined configuration to the substrate, such that the optical elements are optically aligned to provide an optical path through the optical system. Improved optical systems are also disclosed.

### CROSS-REFERENCE TO RELATED APPLICATIONS

This application claims priority from U.S. Provisional Patent Application No. 60/968,794, filed Aug. 29, 2007 and from U.S. Provisional Patent Application No. 60/969,564, filed Aug. 31, 2007. The contents of both these applications are incorporated herein by reference.

### BACKGROUND

1. Technical Field

Planar construction methods are disclosed for the assembly of optical systems. In particular, planar construction methods are disclosed for the assembly of optical systems for optical touch sensors, however it will be appreciated that this disclosure is not limited to this particular field of use.

2. Description of the Related Art

The following discussion of the prior art is provided to place this disclosure in an appropriate technical context and enable the advantages of it to be more fully understood. It should be appreciated, however, that any discussion of the prior art throughout the specification should not be considered as an express or implied admission that such prior art is widely known or forms part of common general knowledge in the field.

The assembly of optical systems requires two or more optical elements to be aligned and fixed with respect to each other in precise fashion, with as many as six degrees of freedom (translation along X, Y and Z-axes and rotation around these axes). The optical elements may for example include passive components such as optical fibers, integrated optical waveguides, beam splitters, reflectors, filters and lenses, active optoelectronic components such as emitters and detectors, and control components such as tunable gratings, electro-optic media and magneto-optic media. Typically, assembly of such optical systems requires complex alignment and attachment of the components based on custom fixture designs, often involving active alignment where light is passed through the system and the various components adjusted to maximize the optical power throughput. These assembly processes are difficult to control, and because of the custom nature of the processes they are difficult to automate using standard automation methods, equipment, and tooling. The difficulty in securing effective automation can make these processes labor intensive and subject to variability. In high volume, these processes require many people working with highly complicated tooling across many manufacturing cells. In addition, optoelectronic components are typically integrated as electrical sub-assemblies (ESAs) to flex circuits, introducing further assembly process challenges that impose higher cycle times, labor intensiveness and tooling complexity that increases cost. Optical alignment and attachment of ESA-based optoelectronic components to passive components such as integrated optical waveguides is difficult and costly.

An example optical system that requires precision alignment of optoelectronic components, integrated optical waveguides and lenses is the waveguide-based optical touch sensor illustrated in plan view in FIG. 1. Sensing light is introduced to the device from a light emitter 2 that may for example be a vertical cavity surface emitting laser (VCSEL) or a light emitting diode (LED), and distributed by a 1×N optical splitter 4 into an array of ‘transmit’ waveguides 6 with integrated planar lenses 8 positioned on an L-shaped substrate 10. The planar lenses collimate the light in the plane of the input area 12 (defined herein as the X-Y plane), and the light then passes into two vertical collimating lenses (VCLs) 14 that collimate the light in the direction perpendicular to the X-Y plane (defined herein as the Z direction) and direct it across the input area in the X direction 16 and the Y direction 18. The light is received by VCLs 14′ on the ‘receive’ side and directed into an array of integrated planar lenses 8′ and waveguides 6′ on another L-shaped substrate 10′ that route the light to a multi-element detector 20, such as a CMOS linear array (i.e. a line camera) or a two-dimensional array (i.e. 2D camera chip). Interruptions in the light grid passing across the input area reduce the amount of light received by certain pixels on the detector chip, and the X, Y coordinates where the interruption occurs are calculated by the system electronics based on these ‘dark’ pixels. It will be appreciated that efficient operation of this touch sensor relies on precise alignment of the various components, specifically the emitter 2, the 1×N splitter 4, the integrated optical waveguide elements 6, 8, 8′ and 6′, the VCLs 14 and 14′, and the detector 20.

There exists therefore, a need for a low cost, high volume assembly method for optical systems, including for example the optical touch sensor shown in FIG. 1, that can leverage automation, reduce cycle time, decrease variability and labor requirements. Published US patent application No 2008/0159694 A1, owned by the present inventor, introduced planar construction concepts whereby optical components are assembled on a common substrate to facilitate their alignment, primarily in the vertical direction (Z-axis). Among other things, this disclosure builds on these concepts by providing assembly methods suitable for automation.

This disclosure provides solutions that overcome or ameliorate at least one of the disadvantages of the prior art, or to provide a useful alternative.

### SUMMARY OF THE DISCLOSURE

This disclosure describes assembly methods for optical systems based on planar manufacturing concepts. These methods are primarily based on using a planar surface as a Z-axis reference for establishing precision Z-axis relationships between various components of an optical system. They are also based on establishing precision X and Y-axis relationships between the components, using machine vision-based ‘pick and place’ automation or fixture-based methods.

In various refinements, this disclosure describes the use of adhesive tape films laminated to flat reference surfaces as a means for establishing the necessary static relationships between optical components. In certain embodiments these adhesive films become a permanent part of the manufactured construction. In other embodiments they serve as a temporary, sacrificial means for effecting static component relationships as a part of a larger manufacturing process where the components are permanently transferred to a system substrate surface following their static alignment to one another,

In another embodiment, this disclosure describes planar construction assembly techniques where additional structures are introduced to provide mechanical strength and environmental protection.

In a further embodiment, this disclosure describes optical system designs based on planar construction where the system substrate serves as a printed circuit board (PCB) enabling planar ‘surface-mount’ attachment of optoelectronic components (e.g. LEDs and CMOS camera chips). This embodiment has particular relevance to optical touch sensors.

This disclosure provides significant advantages over the prior art, for example reduced complication in installation, improved alignment of optical elements and relatively reduced manufacturing costs. Other advantages will be readily apparent to the skilled person. In the context of optical touch sensor assemblies, this disclosure may be distinguished from the prior art in that the collimating lens elements and waveguides are all positioned, formed or configured on a common substrate that provides a common optical axis, thereby providing an optical path through the assembly. The preferred substrate comprises a uniform support surface which acts as a mechanical and optical datum for the various system components. It will be clear to the skilled person that such a configuration provides significant improvements in optical alignment in the Z-axis, as well as tilt about the X and Y axes. Furthermore, when the disclosed optical system is fabricated on a single substrate having both transmit and receive sides of an optical touch system, alignment in the remaining three degrees of freedom (X and Y axes and tilt about the Z-axis) is additionally provided.

In an alternative embodiment, the plurality of waveguides and the unitary collimating lens element are produced separately and attached to the substrate. To facilitate correct positioning of these optical elements on the substrate, certain elements may include a positioning formation for engagement with a complementary formation on the substrate. For example the positioning formation may be a projection, a slot or a recess and the substrate may be manufactured with a complementary formation, such as a slot, a ridge or a protrusion. In preferred embodiments the optical elements are adapted for irreversible press-fit engagement with the substrate.

A key problem for manufacturing low cost, high volume, commercially viable optical systems in the prior art is the large number of assembly tolerances that result when discrete components are brought together and integrated in the assembly process that creates the optical system. This disclosure surprisingly avoids these problems by providing a common reference surface upon which the various system components are either engaged to or formed upon. It will be appreciated that both embodiments discussed in the foregoing, namely, the optical system that results from attaching various optical elements to the common substrate, and simultaneously forming the optical elements either together and attaching to the substrate or integrally with the substrate, fall within the purview of this disclosure. In all of the aforementioned embodiments, the commonality is that the various system components are disposed upon a common substrate that provides an optical, and optionally a mechanical, datum, thereby providing an optical path through the assembly.

According to a first aspect this disclosure provides a method for assembling an optical system, said method comprising the steps of: providing a substrate; providing a plurality of optical elements; arranging and selectively retaining said optical elements in a predetermined configuration; and applying said plurality of optical elements in said predetermined configuration to said substrate, such that said optical elements are optically aligned to provide an optical path through said optical system. Desirably the optical path is substantially parallel to the substantially planar surface.

The optical elements may be are selected from the group consisting of optical fibers, integrated optical waveguides, lenses, emitters, detectors, tunable gratings, beam splitters, filters, reflectors, electro-optic media and magneto-optic media.

The substrate may comprise a substantially planar surface for defining an optical datum for the optical elements. In preferred embodiments the planarity of the substantially planar surface varies by less than 0.4 micron(μm)/cm in the X and Y directions.

The optical elements may be optically aligned in the X and Y directions during arranging of the optical elements in the predetermined configuration. In one embodiment the optical elements are applied simultaneously to the substrate. However, in an alternative embodiment the optical elements are applied sequentially to the substrate.

The optical elements may be retained in the predetermined configuration on a sacrificial or temporary platform prior to being applied to the substrate, wherein the sacrificial or temporary platform comprises a substantially planar surface for defining an optical datum for the optical elements. The planarity of the sacrificial or temporary platform preferably varies by less than 0.4 micron(μm)/cm in the X and Y directions. The sacrificial or temporary platform is preferably selected from the group consisting of a vacuum table, a template, a selectively releasable adhesive sheet and combinations thereof. It will be appreciated that the template may comprise at least one of the group consisting of recesses, slots, apertures, depressions, grooves, troughs and cavities adapted to receive an optical element.

In certain embodiments, the template enables the optical elements to include elements of different heights in the Z direction.

In certain embodiments, the optical elements include a planar vertical collimating lens and a waveguide, wherein the planar vertical collimating lens is significantly taller than said waveguide in the Z direction.

The adhesive sheet is laminar and substantially incompressible or resiliently deformable. The planarity of the adhesive sheet when retained on the platform preferably varies by less than 0.4 micron(μM)/cm in the X and Y directions.

The disclosed methods may further comprise the step of releasing the optical elements from the sacrificial or temporary platform after the optical elements have been applied to the substrate.

The disclosed methods may also further comprise the step of retaining a first side of the adhesive sheet on at least a selected portion of the sacrificial or temporary platform and selectively attaching a first surface of each of the optical elements onto a second opposite side of the adhesive sheet, and once the plurality of optical elements are applied in the predetermined configuration to the substrate, removing the adhesive sheet from the optical elements. The second surface of each of the optical elements may attached to the substrate by an adhesive adapted to accommodate differences between heights of the optical elements.

The disclosed methods may also further comprise the step of attaching one or more further optical elements to the substrate.

The substrate may be electrically conductive. The electrically conductive substrate may be a circuit board.

In a refinement, optical system are disclosed as prepared by any one or more of the methods disclosed herein. In another refinement, a method is disclosed for assembling an optical system comprising a plurality of optical elements, the method comprises the steps of: providing a substrate comprising a substantially planar support surface; selectively retaining a first side of an adhesive sheet on at least a portion of said support surface; and attaching a first surface of each of said plurality of optical elements onto a second opposite side of said adhesive sheet such that said optical elements are optically aligned to provide an optical path through said optical system.

Preferably the planarity of the adhesive sheet varies by less than 0.4 micron(μm)/cm in the X or Y directions when said adhesive sheet is retained on the support surface.

In a refinement, preferably two adhesive sheets are provided in the form of a stack with a release liner between them, wherein the lower adhesive sheet is selectively retained on the support surface and the upper adhesive sheet is selectively releasable from the lower adhesive sheet. Preferably, the adhesive sheet is removed from the support surface.

In a refinement, the method further comprises the step of selectively retaining the substrate on a manufacturing platform during assembly. For example, the substrate may be selectively retained on the manufacturing platform by vacuum or a selectively releasable adhesive.

The substrate may further comprise at least one recess shaped to accept at least one of the optical elements.

In a refinement, at least one of said optical elements comprises a positioning recess for mating with a corresponding positioning formation on said substrate. Alternatively, at least one of said optical elements comprises at least one positioning formation for mating with a corresponding positioning recess on said substrate.

A disclosed method may further comprise the step of arranging and selectively retaining the optical elements in a predetermined configuration, and attaching the plurality of optical elements in the predetermined configuration to the second opposite side of the adhesive sheet. The optical elements may be arranged and selectively retained on a template or an adhesive sheet.

An assembly for an optical system is disclosed, said assembly comprising: a substrate; a cover plate for covering underlying optics or electronics; a planar vertical collimating lens comprising a first surface and a second surface, wherein said first surface is adapted for sealing engagement with said cover plate and said second surface is adapted for sealing engagement with said substrate.

The optics may include a waveguide adjacent the planar vertical collimating lens.

The cover plate may comprise a support engageable with the substrate for enclosing the optics or electronics from the environment.

The support may comprise at least one positioning recess for engagement with a corresponding positioning formation on said substrate. Alternatively, the substrate comprises at least one positioning recess for engagement with a corresponding positioning formation on the support.

The planar vertical collimating lens may comprise at least one positioning recess on the first surface for engagement with a corresponding positioning formation on the cover plate, and/or the planar vertical collimating lens comprises at least one positioning recess on the second surface for engagement with a corresponding positioning formation on the substrate.

The cover plate and the planar vertical collimating lens may define a bezel. Further, preferably the cover plate is the top case of the device comprising the assembly, or a housing or enclosure for the device comprising the assembly.

The first surface may be adapted for sealing engagement with the cover plate and/or the second surface is adapted for sealing engagement with the substrate by any one or more of the group consisting of liquid adhesives, pressure-sensitive adhesives, mechanical structures, press fits, detents, kinematic structures, mechanical alignment structures or datums such that the resultant mechanical strength of the assembly is relatively improved.

The planar vertical collimating lens may provide a refractive lens function or refractive surfaces that affects the light path through the optical system.

The assembly may further comprise a compressible foam disposed subjacent the cover plate for protection of the waveguide.

A method for assembling an optical system is disclosed, said method comprising the steps of: providing a substrate; providing a cover plate for covering underlying optics or electronics; providing a planar vertical collimating lens comprising a first surface adapted for sealing engagement with said cover plate, and a second surface adapted for sealing engagement with said substrate; and positioning said planar vertical collimating lens intermediate said substrate and said cover plate and forming a seal there between.

A method for assembling an optical system is disclosed, said method comprising the steps of: providing a substrate; providing a cover plate for covering underlying optics or electronics; providing a plurality of optical elements;

arranging and selectively retaining said optical elements in a predetermined configuration; applying a first surface of each of said plurality of optical elements in said predetermined configuration to said substrate or said cover plate, such that said optical elements are optically aligned to provide an optical path through said optical system; and attaching to a second opposite surface of one or more of said plurality of optical elements a cover plate or a substrate respectively.

The cover plate may include a support engageable with said substrate for enclosing at least a portion of at least one of said plurality of said optical elements thereby isolating said optical elements from the environment. Preferably the support comprises at least one positioning recess for engagement with a corresponding positioning formation on said substrate, or said substrate comprises at least one positioning recess for engagement with a corresponding positioning formation on said support.

The cover plate may be adapted to engage said planar vertical collimating lens to protect said waveguide from the environment.

The planar vertical collimating lens may comprise at least one recess for engagement with a corresponding positioning formation on said substrate, and/or or said planar vertical collimating lens comprises at least one recess for engagement with a corresponding positioning formation on said cover plate.

The cover plate and the planar vertical collimating lens may define a bezel.

Other advantages and features will be apparent from the following detailed description when read in conjunction with the attached drawings.

### BRIEF DESCRIPTION OF THE DRAWINGS

For a more complete understanding of the disclosed methods and apparatuses, reference should be made to the embodiment illustrated in greater detail on the accompanying drawings, wherein:

FIG. 1 illustrates a plan view of a prior art waveguide-based optical touch sensor:

FIGS. 2A, 2B and 2C illustrate the attachment of double-sided pressure-sensitive adhesive tape to a flat reference surface;

FIGS. 3A and 3B illustrate the attachment of a second layer of double-sided pressure-sensitive adhesive tape onto a primary pressure-sensitive layer bonded to a flat reference surface;

FIGS. 4A, 4B and 4C illustrate the attachment and release of a double-sided, pressure-sensitive, ultraviolet release tape;

FIGS. 5A, 5B and 5C illustrate a double-sided pressure-sensitive tape temporarily attached to a mechanical reference surface by vacuum;

FIGS. 6A, 6B and 6C illustrate the construction of an optical touch sensor based on permanent bonding to a system substrate with double-sided, pressure-sensitive adhesive tape;

FIGS. 7A, 7B and 7C illustrate the use of double-sided pressure-sensitive ultraviolet release tape for attachment of planar VCLs to a system substrate;

FIGS. 8A and 8B illustrate the attachment of planar VCLs to a ‘continuous’ system substrate and a ‘frame-based’ system substrate respectively;

FIGS. 9A, 9B and 9C illustrate the assembly of an optical touch sensor based on the attachment of polymer waveguides to a system substrate with bonded planar VCLs;

FIGS. 10A, 10B and 10C illustrate the of use of double-sided pressure-sensitive adhesive tape in the assembly of an optical touch sensor where the system substrate is attached to the waveguides and the planar VCLs at the same time;

FIG. 11 shows a plan view of a vacuum fixture;

FIGS. 12A, 12B and 12C illustrate the assembly of an optical touch sensor using a vacuum fixture;

FIGS. 13A, 133B and 13C illustrate the assembly of an optical touch sensor with additional structure elements to strengthen the assembly and to protect the components;

FIGS. 14A, 14B and 14C illustrate the attachment of optoelectronic components to a system substrate;

FIGS. 15A and 15B show plan views of the assembly of an optical touch sensor on an electrically active system substrate; and

FIGS. 16A and 16B illustrate an alternative assembly of an optical touch sensor.

It should be understood that the drawings are not necessarily to scale and that the disclosed embodiments are sometimes illustrated diagrammatically and in partial views. In certain instances, details which are not necessary for an understanding of the disclosed methods and apparatuses or which render other details difficult to perceive may have been omitted. It should be understood, of course, that this disclosure is not limited to the particular embodiments illustrated herein.

### DETAILED DESCRIPTION OF THE PRESENTLY PREFERRED EMBODIMENTS

### DEFINITIONS

In describing and claiming the various embodiments, the following terminology will be used in accordance with the definitions set out below. It is also to be understood that the terminology used herein is for the purpose of describing particular embodiments, only and is not intended to be limiting. Unless defined otherwise, all technical and scientific terms used herein have the same meaning as commonly understood by one having ordinary skill in the art to which this disclosure pertains.

Unless the context clearly requires otherwise, throughout the description and the claims, the words ‘comprise’, ‘comprising’, and the like are to be construed in an inclusive sense as opposed to an exclusive or exhaustive sense; that is to say, in the sense of ‘including, but not limited to’.

The recitation of a numerical range using endpoints includes all numbers subsumed within that range (e.g., 1 to 5 includes 1, 1.5, 2, 2.75, 3, 3.80, 4, 5, etc.).

The terms ‘preferred’ and ‘preferably’ refer to embodiments that may afford certain benefits, under certain circumstances. However, other embodiments may also be preferred, under the same or other circumstances. Furthermore, the recitation of one or more preferred embodiments does not imply that other embodiments are not useful, and is not intended to exclude other embodiments from the scope of this disclosure.

An important enabling concept in this disclosure, particularly for optical touch sensors, is the ‘planar vertical collimating lens’ (planar VCL or PVCL), defined herein as a lens capable of collimating light in the vertical (Z-axis) direction and having a planar surface adapted for attachment to a planar substrate. Refracting surfaces of any shape, combination, or design can be considered planar vertical collimating lenses providing the bottom surface of the lens enables a planar construction interface between the lens bottom surface and the top surface of a waveguide substrate or a touch sensor system substrate, and directs light along the optical axis of the touch sensor system as detailed in the optical touch sensor construction embodiments.

The term template refers to a substantially planar surface comprising one or more recesses, slots, apertures, depressions, grooves, troughs or cavities adapted to receive and accurately hold one or more optical elements during assembly of an optical system. It may include the use of vacuum to hold the optical elements within the recesses, slots etc.

A key problem in the manufacture of low cost, high volume, commercially viable optical touch sensors in the prior art is the large number of assembly tolerances that result when discrete components are brought together and integrated in the assembly process. Certain designs of optical touch sensors in the prior art do not enable low cost manufacturing processes. Individual component designs are a major factor in being able to achieve an overall system design that can be manufactured in high volume and at low cost, and many component design embodiments in the prior art hinder this ability. The basic issue is that optical touch sensor constructions and construction variants based on these prior art component designs make high volume, low cost manufacturing difficult.

This disclosure overcomes limitations in the prior art by introducing planar optical touch sensor construction based on aligning and attaching system components in sequential steps adjacent to or on top of one another. In this way, the components are utilized as planar entities. The crucial advantage of planar based construction over prior art assembly methods is that it allows the precision registration of optical components with respect to one another in X, Y and Z using a plane as a reference for the assembly. This reduces complex tolerance stack-ups by enabling a simpler, more manufacturable system design. In addition, planar optical touch sensor construction enables manufacturing process design based on high precision, high volume automation processing that enables high yield and low cost manufacturing processes. This is in contrast to complex, custom process design based on the non-planar optical touch sensor construction of the prior art, described in more detail in US 2008/0159694 A1. In addition, the planar optical touch sensor construction of this disclosure provides a common mechanical reference for the attachment of optical system components. This common reference surface enables a less complex system of mechanical alignment and component adjustment for working optical touch sensor systems, in particular by providing the optical axis for the system, i.e. the path along which light propagates with minimum loss.

This disclosure introduces assembly methods for optical touch sensors based on the planar attachment of system components to laminar, pressure-sensitive adhesive tape film surfaces (i.e. PSA surfaces) that serve as a basic Z-Axis reference for the resulting construction. The PSA surfaces can be made extremely flat with a ‘total-indicated-run-out’ of less than one micron per inch (1 micron per approx. 2.5 cm length in the X and Y directions), with the flatness in large measure depending on the surface to which the films are attached or laminated. A key benefit of the extremely flat adhesive tape film surface in this disclosure is that it enables the use of precision ‘vision-based pick and place robot transfer’ of components to this surface without movement following the transfer, because the adhesive tape film's surface holds the components in place. The tape film's underlying mechanical reference defines the Z-axis positioning of the components with respect to each other and with respect to the overall assembly. In addition, high precision vision-based pick and place robot transfer systems enable accurate establishment of X and Y-axis relationships between components. Placement accuracy between components transferred to tape film can be in the micron range, with a standard deviation of 1 to 2 μm. Components can be transferred accurately at high speed, offering advantages in manufacturing processes for touch sensors not found in prior art embodiments. Acrylic-based PSA tapes are used in the assembly of cell phones, display applications, underwater cameras, and many other consumer product applications. These applications require careful placement in the X and Y-axes, but do not utilize the Z-axis referencing property developed and exploited in this disclosure.

A principal problem for the implementation of vision-based pick and place automation for high accuracy applications is how to hold the components in place after the robot delivers them. In many cases the robot must deliver a component to a liquid adhesive, so the component can move or drift after delivery as a result of factors such fluid dynamics and gravity. In addition, the Z-axis positioning of a component on a liquid adhesive can depend on the pressure exerted by the pick and place robot, and differential shrinkage of the adhesive during curing can also cause component movement. Deviations from the intended positions of components caused by such movement can be significant, increasing the optical loss of the system. They can be ameliorated somewhat if the pick and place robot holds the components in place during the curing process, but the additional ‘hold time’ consumes valuable cycle time and involves the integration of custom adhesive curing systems to the automation process, making it more complex and expensive. The addition of a hold to enable adhesive to be cured in place can also affect the accuracy of the resulting mechanical design. In addition, some touch sensor design embodiments found in the prior art require placement of components onto tilted ‘off-axis’ surfaces, which introduces more complexity. This disclosure offers significant improvements over the prior art by enabling the implementation of simple high speed, low cost vision-based pick and place technology for the assembly of optical systems, and optical touch sensors in particular. Compared with liquid adhesives, the tape films used in certain assembly methods of this disclosure offer more accurate Z-axis positioning of components by being either substantially incompressible or resiliently deformable. That is, the final Z-axis positioning does not depend on the pressure exerted by the pick and place robot.

This disclosure, as it pertains to tape film transfer, has one embodiment (the ‘Temporary Embodiment’) based on the use of the tape film transfer as an intermediate step in a larger process, and another embodiment (the ‘Permanent Embodiment’) based on the use of the tape film as a permanent part of the resulting assembly. In the Temporary Embodiment the precision mechanical relationships of the touch sensor components are established temporarily across the tape film surface. The components are usually fixed to the tape film's surface in upside-down fashion, and an adhesive (such as a liquid or film-based adhesive) is then applied to the back surface of the components enabling bonding to a system substrate or other structure that is presented to the back surface. The nature of this process creates extremely accurate relationships between the top surfaces of the components with respect to their Z-axis relationships, because they are mated to a flatness reference under the tape. When a liquid adhesive is used the bond-line between the components' back surfaces and the system substrate is able to ‘float’ or change, absorbing variation between thicknesses of components to tiny levels.

In the Temporary Embodiment, the flatness reference and bonded tape film surface can be removed after the component attachment and ‘staged’ with components aligned for subsequent process steps that can be performed in another location and at another time. This offers advantages over prior art in ‘work-in-process’ (i.e. WIP) management on the factory floor. In addition, ‘hard-stop’ mechanical references, and other references, can be added to the tape film's surface in precision relation to the components, to enable accurate X, Y alignment and attachment of the system substrate or other structure to components' back surfaces. After completion of the assembly process the adhesive tape film needs to be removed from the components. This can be facilitated by using tape films with sufficiently low tack such that the resulting assembly is simply peeled off with little mechanical resistance. Alternatively, tape removal can be facilitated by using tape films that release after exposure to ultraviolet light. With these ‘UV tapes’ the tack is turned-off, at the end of the assembly process by flood exposure to ultraviolet light, for example through transparent optical flats to which the tape is laminated. Tape removal can also be enabled with a selective chemical that only removes tape film.

In the Permanent Embodiment, a pressure-sensitive adhesive (PSA) tape film is attached to the system substrate, for example by spray coating or lamination, and touch sensor components are then bonded permanently to this PSA surface using a planar based manufacturing approach. The relationships in X, Y and Z between components are established across the plane of this tape film surface.

In one optical touch sensor embodiment, the system substrate is continuous or uninterrupted and will therefore cover the video display surface following touch sensor integration into a final display application. In this embodiment, the continuous touch sensor substrate will serve as a ‘coverlay’ or protective covering over the video display, offering enhanced mechanical rigidity and display surface protection. Since the portion of the substrate over the display needs to be transparent, the pressure-sensitive adhesive must be applied selectively around the periphery of the substrate, preferably only in the places where the touch sensor components will be attached, to enable openings through to engineered structures on the system substrate for example.

In another optical touch sensor embodiment the system substrate is ‘interrupted’, i.e. in the form of a frame that remains restricted to the ‘under-bezel’ area of the video display surface following its integration into a display device. The frame-like system substrate can be coated with a permanent pressure-sensitive adhesive to enable the permanent transfer of components to its surface. ‘Frame’ and ‘continuous’ substrates can both be used in either the Temporary Embodiment or the Permanent Embodiment.

This disclosure also describes the use of mechanical fixture-based concepts that leverage planar-based optical touch sensor construction. Also described are mechanical fixtures that reference the top surfaces of components and enable the attachment of these components by a ‘floating-bond-line’ where the adhesive's ‘bond-line’ changes as necessary based on the gap between the surfaces to be bonded together. The ‘floating-bond-line’ strategy manages differences in Z-axis component dimensions by absorbing them through changing the bond-line thickness. In addition, this disclosure describes the use of atmospheric pressure to apply a load on components through the use of vacuum fixtures to prevent component movement during assembly and to ensure that the components are properly referenced to mechanical datums. This disclosure also describes the integration of much larger planar vertical collimating lenses (planar VCLs) to the optical touch sensor assembly, via the precision use of recessed features in the vacuum chuck surface. In this manner, the vacuum chuck surface serves as a template. Such lenses, with their much larger apertures, represent an improvement over prior art embodiments by enabling more efficient optical design that reduces system optical power loss.

This disclosure also describes additional elements in an optical touch sensor mechanical construction that help to strengthen it and avoid movement or change in the precision optical relationships that would impair proper system function. Impaired performance of optical touch sensor systems resulting from mechanical deflection during use, torsion and other mechanical effects induced by temperature changes, or from differentials in material physical properties have been an issue in prior art embodiments. This disclosure introduces the use of additional mechanical elements to protect the optical construction, through the creation of a construction based on an ‘inside environment’. This ‘inside environment’ construction is a sealed mechanical enclosure that protects the touch sensor components from the effects of the ‘outside’ environment such as moisture, particulates and other contamination, in addition to strengthening the assembly. It will be referred to as the ‘System Enclosure’ in the present specification, which describes construction embodiments enabled by the planar nature of the optical touch sensor design. The System Enclosure may include mechanical elements from the top case and bezel of the associated video display device, as well as the planar VCLs. The planar VCL design enables important embodiments of the System Enclosure, in particular by forming part of the bezel that encloses the system.

This disclosure describes the attachment of optoelectronic components including Edge-Emitting Lasers, LEDs, VCSELs and CMOS linear array camera chips, for example through the use of planar methods utilizing vision-based pick and place robots. Methods where these components are aligned and transferred to the surface of a system substrate in precision relation to other optical system components are described. This disclosure introduces the concept of an electrically active system substrate that serves as a printed circuit board as well as being the system substrate, enabling electrical connections between components to be made. This offers advantages over embodiments in the prior art where flex circuit based Electrical Sub Assemblies (ESAs) are employed to establish system electrical connectivity between components. Flex circuits are difficult to handle, and the precision attachment of optical components based on them requires complex tooling, custom end effectors, custom adhesive application and curing processes, and labor intensive methods. The planar-based methods of this disclosure offer advantages by enabling vision-based pick and place transfer of components directly to the system substrate. These planar transfers can be extremely accurate, for example placing an emitter to within 1 or 2 microns of the terminus of the 1×N optical splitter of an optical touch screen sensor. Attachment of the CMOS camera chip to the receive waveguide tail terminus requires less accuracy.

After precision transfer to the system substrate, the optical interface between an optoelectronic component and its corresponding optical waveguide terminus is bonded with an index-matched adhesive, as needed, followed by electrical attachment to the system substrate using wire bonding. The entire component-to-waveguide joint is then reinforced with a structural adhesive that surrounds the component region on a larger scale and also ‘glob-tops’ the wires of the wire bond. This final structural adhesive can add significant strength to the construction. Components can be attached to the system substrate with the assistance of optical alignment targets when machine vision is employed for the alignment process. These targets can be features engineered into the surface of the system substrate to provide a common ‘global’ reference frame for the alignment of all components across the surface, or they can be specific features such as fiducials printed for example onto waveguide structures that result in the formation of a ‘local’ reference frame.

This disclosure describes the application of patterned pressure-sensitive adhesive (i.e. PSA) to a system substrate, for example by laminating precision die-cut sheet films to the system substrate through vacuum lamination, roll lamination and other methods that ensure a continuous, gas and particle free interface between the PSA tape and the system substrate. Patterned pressure-sensitive adhesive films can also be applied to a system substrate in liquid or aerosol form through screens or masks. Other methods can be used. The patterned application of PSAs enables electrical bond pads on the surface of a system substrate, required for electrical component connections, to be exposed and free from the tape film required for component attachment in other places. The use of patterned adhesives can offer other manufacturing advantages. For example precision application of patterned PSAs confines the adhesive to specific regions of the touch sensor assembly where they are needed, so that it does not hinder, encroach, or interfere with other surfaces where adhesive is not required. In particular, exposed adhesives can cause contamination issues.

Attachment of an optoelectronic component to a system substrate requires the optically active surface of the component to be presented to the end face(s) of the optical waveguide(s). This requires ‘transverse’ chip orientation for many components, and in the camera chip case it results in camera chip bond pads that do not ‘point up’ after attachment to the system substrate, but rather point sideways (i.e. transversely), along with the camera chip's pixel cells, facing the end faces of the receive waveguides. This introduces electrical connection challenges because the bond pads on the camera chip are not accessible to the wire bond process that follows camera chip bonding to the system substrate. Transverse chip attachment requires special packaging for the chip that establishes the wire bonded electrical (or in some cases ‘flip-chip’) connection from the chip to this package. The package's electrical design must enable wire bond attachment to the system substrate in a standard, planar way, from the bond pads on the package's top surface to bond pads on the top surface of the system substrate. Components such as Edge-Emitting Lasers where electrical connection is made to a surface orthogonal to the emitter surface enable bare die attachment of the chip to an optical touch sensor system without a package. That is, these chips are already designed for ‘transverse’ attachment. The packaging cost can be considerable. This disclosure based on planar component attachment to an electrically active system substrate offers advantages over prior art embodiments by reducing cost, complexity, and cycle time, considering chip packaging costs resulting from transverse chip attachments.

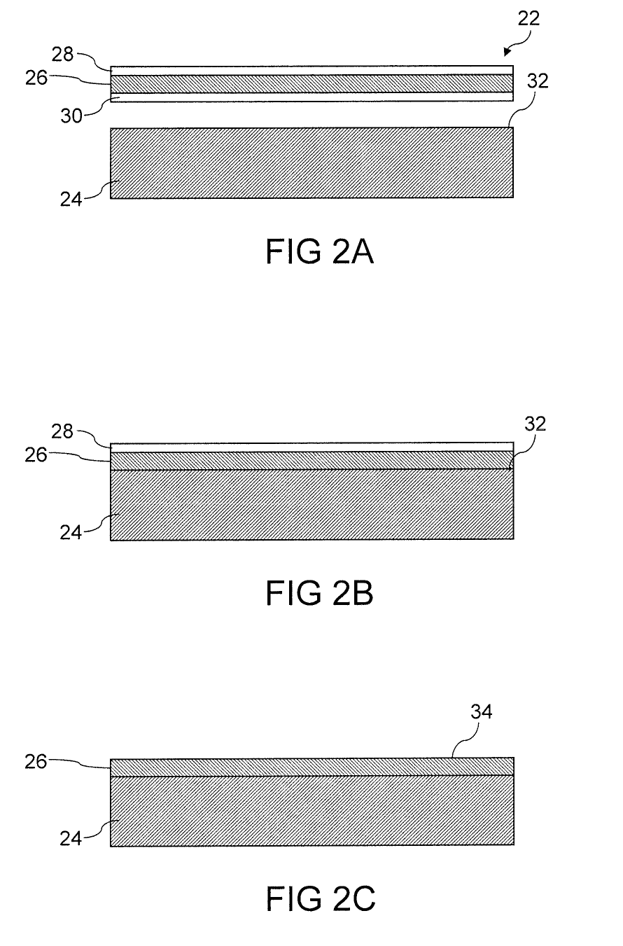

The attachment of a laminar sheet of double-sided pressure-sensitive adhesive tape 22 to a reference flat 24 is shown in cross-section in FIGS. 2A, 2B and 2C. FIG. 2A shows a tape sheet 22 consisting of a layer of pressure-sensitive adhesive 26 between two protective liners 28, 30 composed for example of Mylar, polyester or polyethylene, and a reference flat 24 that may be composed of a variety of materials including metal, ceramic, glass and quartz. It is important that its surface 32 be extremely flat, and variations of less than 1 micron per inch (0.4 μm/cm) are possible through industrial lapping and polishing processes. In FIG. 2B the lower liner 30 has been removed and the adhesive layer 26 laminated to the surface 32 of the reference flat, and in FIG. 2C the upper liner 28 has been removed to expose the surface 34 of the adhesive layer that provides a flat reference for planar attachment of components. For example the tape-laminated reference flat can be transferred to the vacuum chuck of a vision-based pick and place automation system or other process technology, to enable the planar attachment of optical components requited for touch sensor assembly. The surface energy of the surface 32 of the reference flat 24 can be adjusted by application of a coating prior to lamination of the tape, to enable different amounts of adhesive ‘tack’ between the adhesive layer 26 and the reference flat.

A variety of industrial tape lamination methods can be used to apply the double-sided pressure-sensitive adhesive tape 22 to the reference flat 24, including vacuum lamination and differential pressure lamination (DPL) on tools of the type made by OPTEK, Blairstown, N.J. and Callendar Rollers, and Hot Roll Laminators of the type made by Western Magnum, El Segundo, Calif. These methods can deliver high quality laminated tape films to the reference surface 32 without bubbles, wrinkles, or particulates. The tape film 22 can be based on a variety of chemistries, and dry film photoresists of the types such as Dynachem from Morton International and Riston from Dupont serve as excellent double-sided, pressure-sensitive adhesives for this disclosure. These films offer the further advantage of being able to be removed in benign aqueous solutions of potassium carbonate, provided that they have not been exposed to white light or polymerizing radiation.

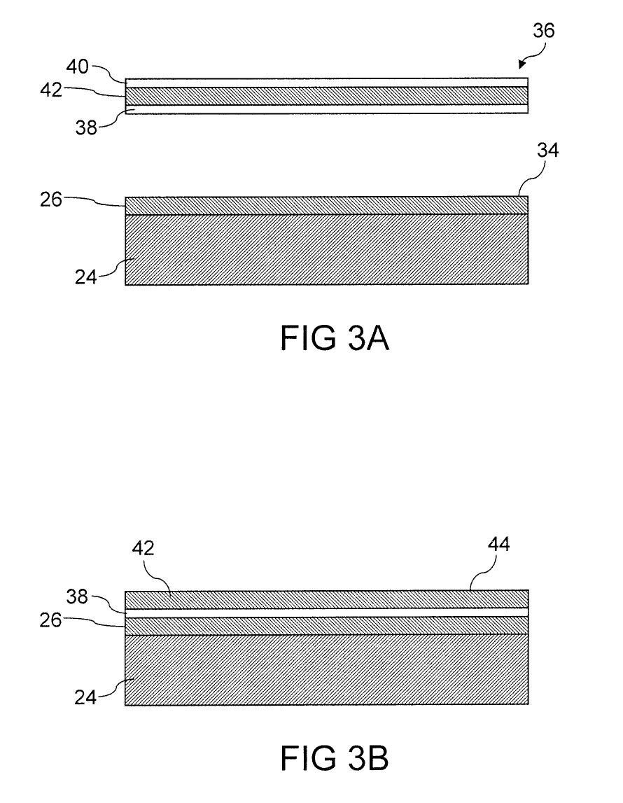

FIGS. 3A and 3B show in cross-section the lamination of a second sheet of double-sided adhesive tape film 36 to the laminated reference flat 24 from FIG. 2C. In this case, the lower liner 38 of the new film 36 is attached to the adhesive film surface 34 already on the reference flat, and the upper liner 40 of the new film removed. This embodiment is important because it enables the second adhesive layer to be removed at the liner 38 interface after optical components have been bonded to its top surface 44. The lower liner 38 can thus serve as the system substrate for embodiments of this disclosure where the second adhesive layer 42 becomes a permanent part of the resulting bonded optical touch sensor assembly.

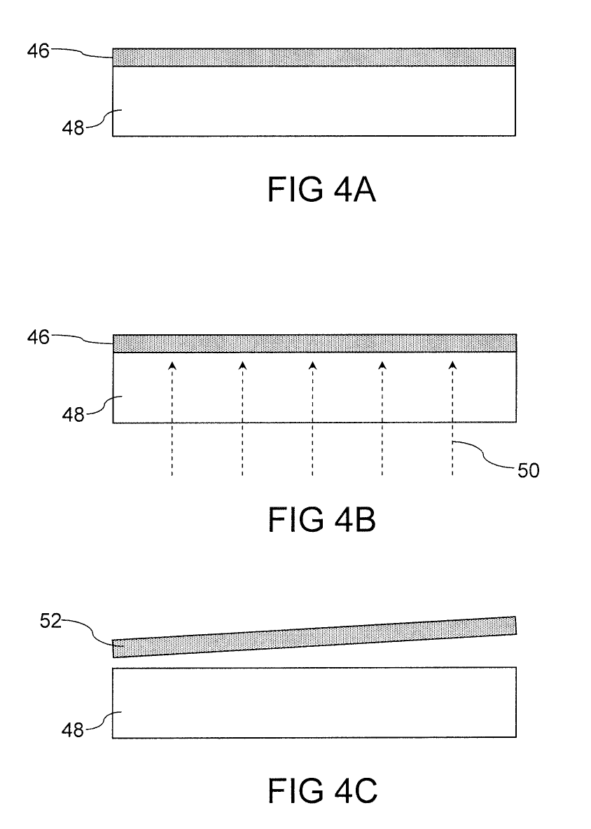

FIGS. 4A, 4B and 4C show in cross-section view the operation of double-sided ultraviolet-release adhesive tape film (i.e. ‘UV tape’). FIG. 4A shows a lapped flat 48 of transparent material such quartz or soda lime glass with a layer of adhesive UV tape 46 laminated thereon by the process shown in FIGS. 2A to 2C. As shown in FIG. 4B the UV tape has its adhesive force dramatically reduced by exposure to ultraviolet light 50 through the transparent substrate 48, enabling separation of the exposed film 52 from the substrate (FIG. 4C). This release property of UV tape enables optical touch sensor components to be bonded to its surface securely but temporarily, using a process such as machine vision pick and place processes. Optical components can be placed on the UV tape surface with accuracy between structures of better than 1 μm at 1 sigma in the X and Y-axes, and better than 5 μm in Z. High tack UV tape film bonded to a low thermal expansion material such as quartz results in a highly stable adhesive bonding surface that can preserve the placement accuracy delivered by pick and place or other transfer technology during bonding.

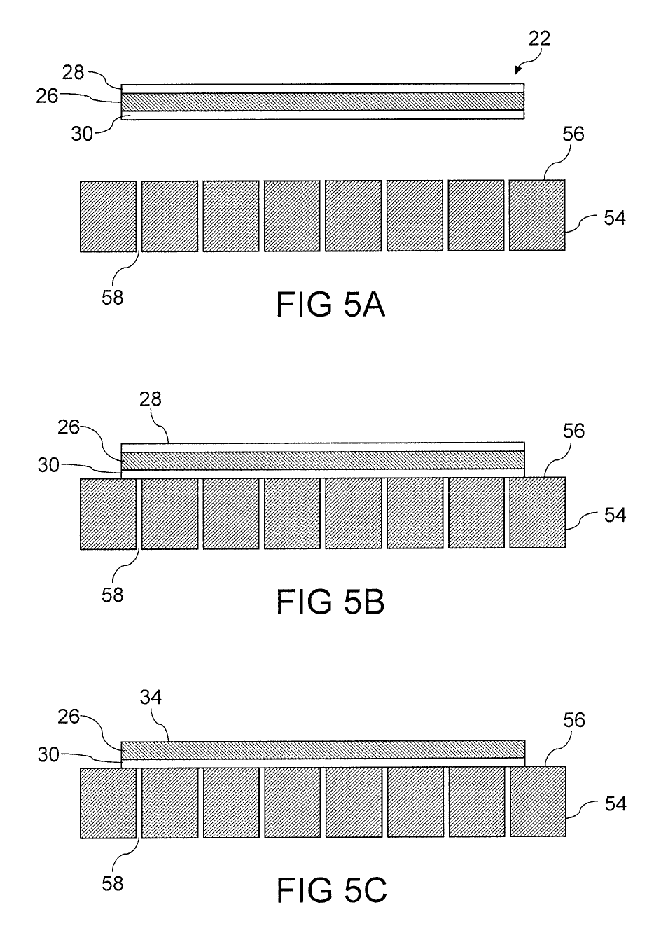

Turning next to FIGS. 5A, 5B and 5C, there is shown in cross-section the placement of a double-sided pressure-sensitive adhesive tape film 22 (comprising an upper liner 28, actual adhesive layer 26 and lower liner 30) on the surface of a vacuum chuck 54. The tape film is securely but temporarily attached to the vacuum chuck by evacuating air from the interface between the lower liner 30 and the precision flat top surface 56 through vacuum ports 58 engineered into the chuck (FIG. 5A). The upper liner 28 is removed (FIG. 5C) for transfer of optical components to the bonding surface 34. In this embodiment the lower liner 30 serves as the system substrate, with the adhesive layer and lower liner removed following the transfer of optical components to the bonding surface 34. The vacuum chuck may for example be a lapped ‘sintered chuck’ where vacuum is pulled through a porous ceramic surface, or lapped stainless steel or other metals, and can be a permanent hardware feature of a vision-based pick and place robot system or other transfer technology.

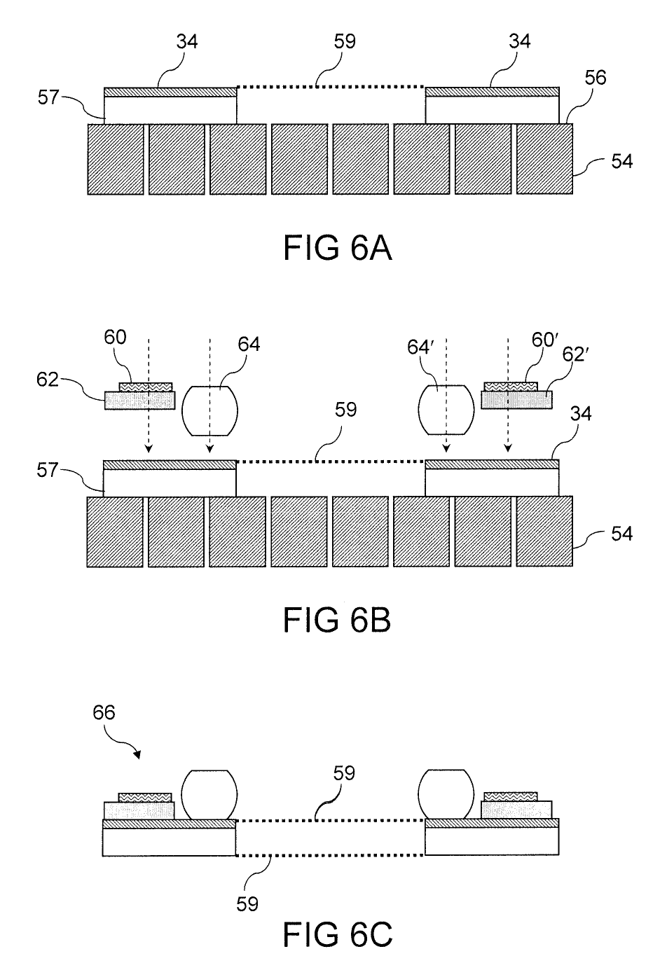

FIGS. 6A, 6B and 6C show in cross-section the planar assembly of an optical touch sensor based on permanent optical component transfer to a pressure-sensitive adhesive (PSA) bonding surface 34 laminated onto a frame-type system substrate 57 that serves as a reference flat as shown in FIG. 2C. As indicated by the dotted lines 59, this system substrate is in the form of a rectangular frame designed to fit around the edge of a display. As shown in FIG. 6A, the system substrate 57 is placed on the ultra-flat surface 56 of a vacuum chuck 54 and held in place with atmospheric pressure. Integrated optical waveguides 60, 60′ composed of polymer (‘polymer waveguides’) on substrates 62, 62′ and planar VCLs (i.e. PVCLs) 64, 64′ are attached with accuracy and precision to the adhesive tape surface 34 using machine vision-based pick and place automation technology (FIG. 6B) and the completed optical system 66 (with the components permanently bonded to the system substrate) removed by release of the vacuum (FIG. 6C). The present embodiment is enabled by the planar nature of the components that can be placed with planar transfers.

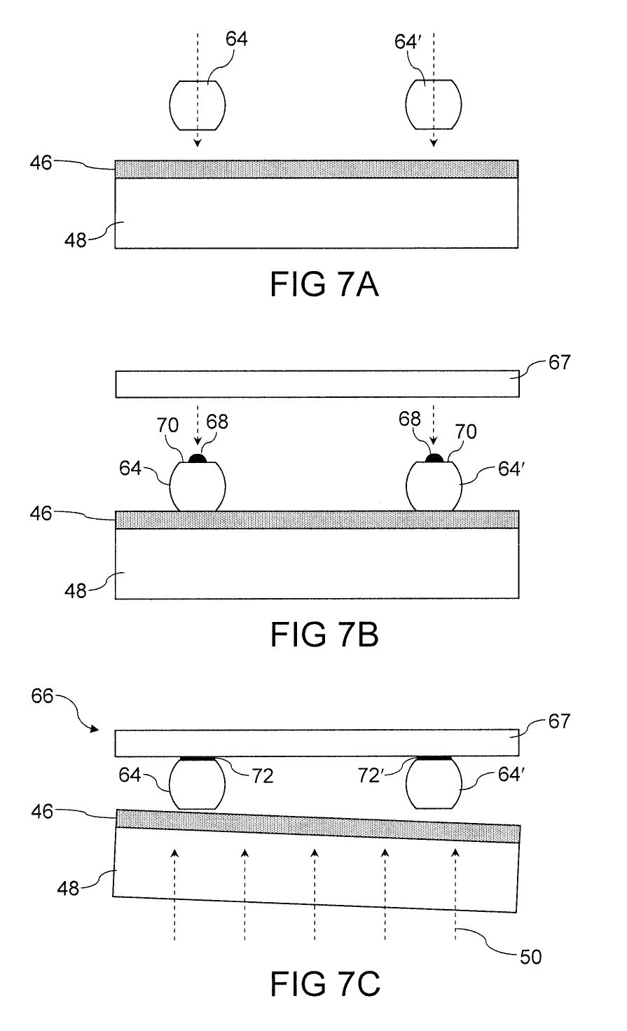

Turning next to FIGS. 7A, 7B and 7C, there is shown in cross-section the planar attachment of two PVCLs 64, 64′ to a continuous' system substrate 67 via temporary bonding to a sheet of UV release tape 46 laminated onto a transparent, ultra-flat quartz tooling surface 48. After placing the PVCLs on the adhesive tape surface (FI(G. 7A), a liquid adhesive 68 is then applied to the back surface 70 of each PVLC to enable attachment of the system substrate 67 (FIG. 7B) at the bond-lines 72, 72′. In FIG. 7C the tack of the UV tape is reduced by flood exposure to UV light 50, enabling removal of the optical system 66.

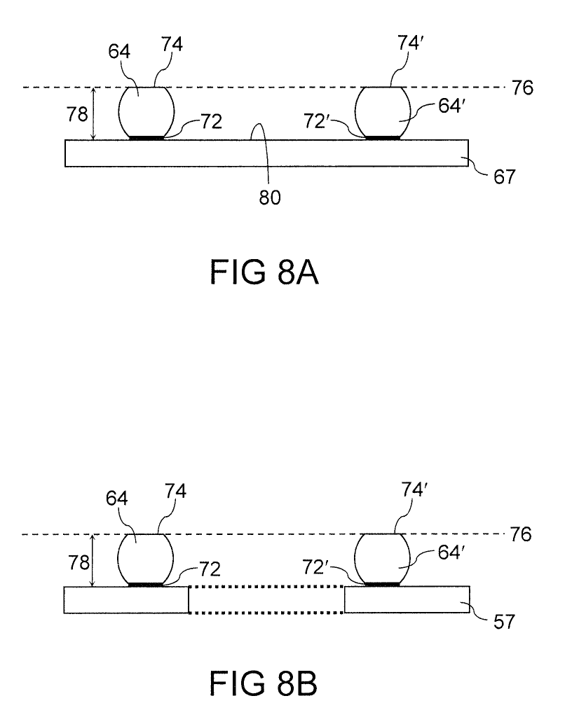

FIGS. 8A shows a cross-section view of a ‘continuous substrate’ touch sensor embodiment assembled by the method illustrated in FIGS. 7A to 7C. The PVCLs 64, 64′ are attached to a continuous system substrate 67 through the adhesive bond-lines 72, 72′. Importantly, the top surfaces 74, 74′ of the PVCLs remain on the same line 76; this is because the thickness of the adhesive in the bond-lines 72, 72′ changes during the bonding process (FIGS. 7A to 7C) to accommodate variations between the two PCVLs, thereby keeping the distance 78 between the PVCL top surfaces 74, 74′ and the top surface 80 of the system substrate 67 the same. Putting it another way, because the PVCLs are temporarily fixed to a reference flat (the UV tape 46 in FIG. 7B), the adhesive bond-lines 72, 72′ are able to change or ‘float’ during the permanent attachment of components, Consequently the distance 78, corresponding to the stack height, can remain extremely consistent, which helps buffer the assembly from variations in PVCL thickness resulting from the capability of the process used to manufacture them. The assembly shown in FIG. 8B differs only in that the system substrate is a ‘frame’ style substrate 57.

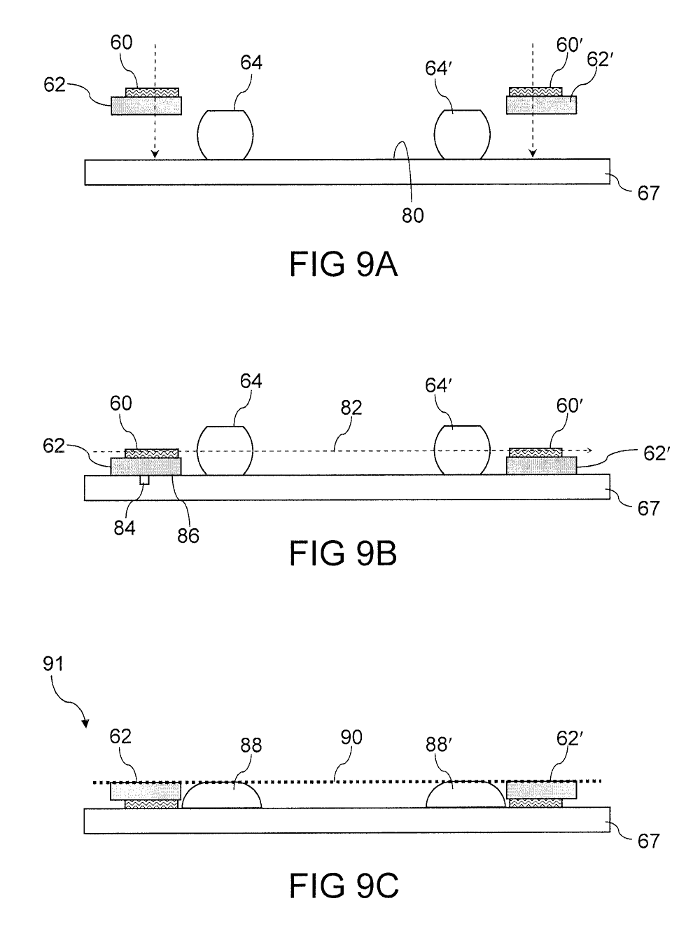

Moving now to FIG. 9A, there is shown in cross-section the completion of a touch sensor construction where polymer waveguides 60, 60′ are attached to the top surface of the system substrate 67 from FIG. 8A, with the attachment made for example by using permanent PSA attached to the bottom surface of each waveguide substrate 62, 62′, patterned PSA attached to the top surface of the system substrate, or liquid adhesive placed on the system substrate by precision machine vision-based automation. As shown in FIG. 9B and explained in more detail in published US patent application No US 2008/0159694 A1, mechanical recesses 84 can be machined into the top surface of the system substrate to assist in liquid glue management by enabling gas removal from the interface 86, resulting in a more consistent bond-line. These recesses or channels 84 can also assist in adhesive delivery by enabling micro-fluidic filling, where capillary forces wick adhesive through the channels, enabling precision application of adhesive to controlled areas of the system substrate without entrained gas. In preferred embodiments the waveguides are placed in X, Y relation to the PVCLs 64, 64′ using vision-based pick and place technology. In the embodiment shown in FIG. 9B where the waveguides are placed substrate-side down, the alignment of the waveguides to the optical axis 82 of the touch sensor system (i.e. Z-axis alignment) is determined by the thickness of the waveguide substrates 62, 62′. In an alternative embodiment shown in FIG. 9C the waveguides are placed substrate-side up on the top surface of the system substrate. This embodiment is useful in achieving Z-axis alignment in situations where the waveguide substrates 62, 62′ are of unreliable thickness. In this particular embodiment, variant ‘half lens’ PVCLs 88, 88′ are attached to the system substrate 67. This FIG. 9C embodiment can alternatively be assembled by aligning the top surfaces of the components to a reference plane 90 by temporary attachment to UV-release tape film, as illustrated in FIGS. 7A to 7C, before permanent transfer to the system substrate 67. This approach is enabled by the use of a floating bond-line and backside substrate attachment to achieve the construction 91. This construction 91 can also be achieved by transferring components directly to a permanent tape film surface on the surface of the system substrate by pick and place automation or other method.

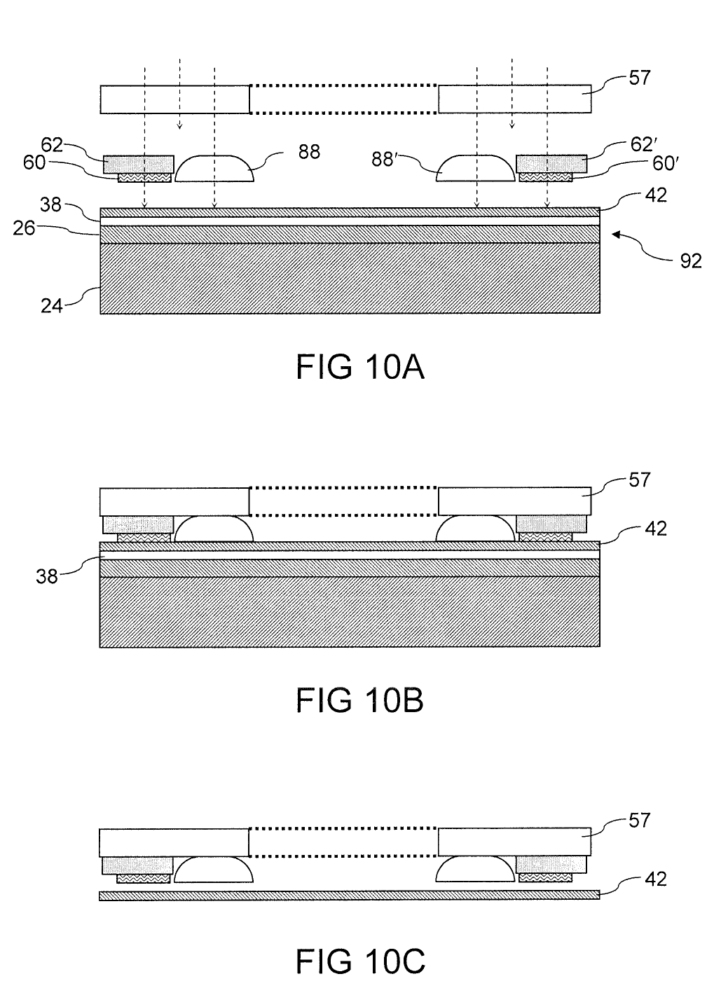

FIGS. 10A, 10B and 10C show in cross-section the construction of an optical touch sensor based on the temporary attachment of polymer waveguides 60, 60′ and ‘half’ lens' PVCLs 88, 88′ to a two-layer PSA tape base 92 produced as shown in FIGS. 3A and 3B, followed by permanent attachment of a frame-style system substrate 57 using a floating bond-line (FIG. 10A). The positioning of the PSA tape layer 42 on the reference flat 24 defines the Z-axis component placement, and the liner 38 enables removal of the completed construction as the adhesive tape layers 26, 42 will not stick to it (FIG. 10B). Provided the PSA tape layer 42 is of relatively low tack, the assembled optical components can then be easily separated from the tape layer (FIG. 10C). Alternatively, the tape layer 42 may be of the UV-release type.

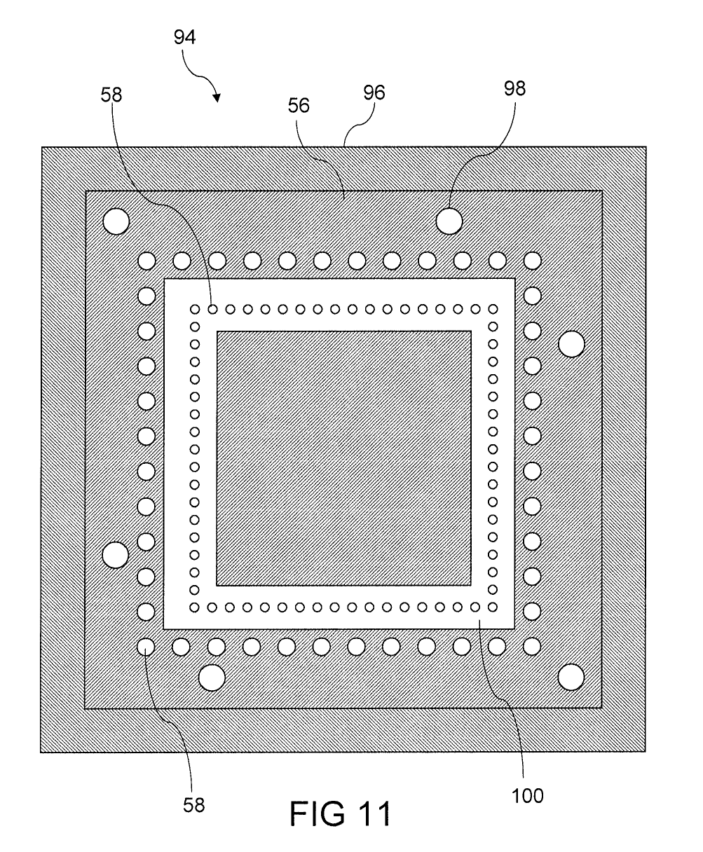

Referring now to FIG. 11, there is shown a plan view of a mechanical fixture 94 used to assemble an optical touch sensor system based on planar construction principles. This fixture includes a mechanical block 96, a lapped tooling surface 56 that serves as a flatness reference for establishing precision Z-axis relationships between components, tooling pins 98 that serve as references for establishing relationships in the X and Y-axes, recesses 100 for PVCLs, and vacuum ports 58 to help prevent movement of the various components. The tooling surface 56 with the recesses 100 serves as a template for the assembly of the optical touch sensor system.

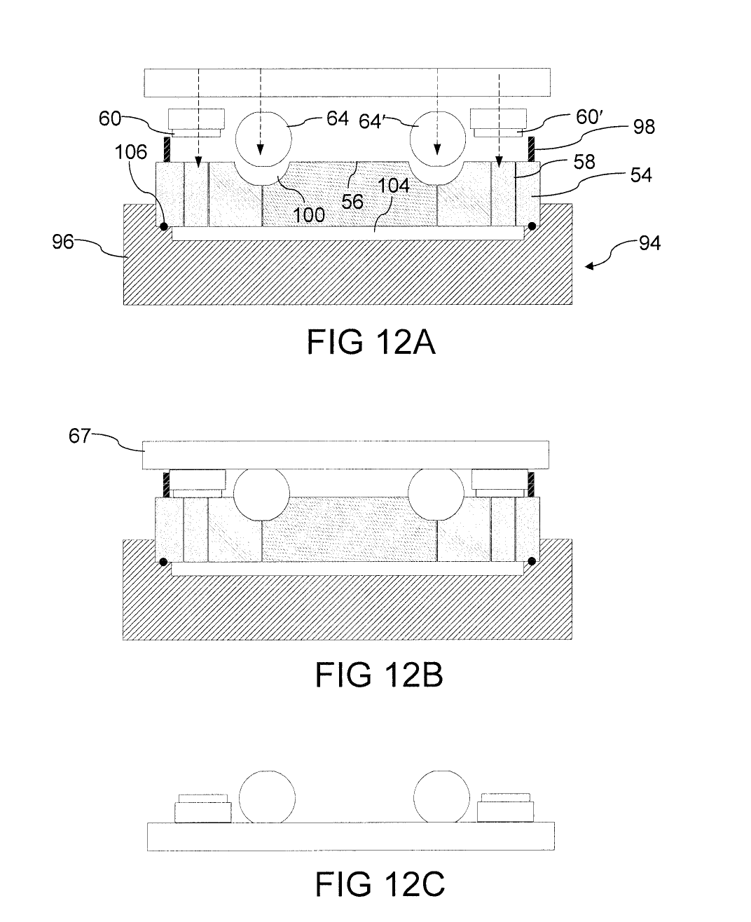

Moving to related diagrams in FIGS. 12A, 12B and 12C, there is shown in cross-section the assembly of an optical touch sensor system on the mechanical fixture 94 shown in FIG. 11. Polymer waveguides 60, 60′ and PVCLs 64, 64′ are placed in the fixture and held in place by evacuation of air through the vacuum ports 58 and the vacuum plenum 104. The machined block 96 that contains the vacuum plenum is sealed at its interfaces with the vacuum fixture by O-ring gaskets 106. The polymer waveguides are referenced with respect to each other in X and Y by the tooling pins 98, and the PVCL relationships in X and Y are defined by the precision machined recesses 100 that can be designed to be kinematic in nature (not shown). Z-axis relationships between the waveguides and PVCLs are defined by the flatness of the lapped tooling surface 56 and the flatness and co-planarity of the bottom surfaces of each recess 100, and their relationships in X and Y to other surfaces of the vacuum chuck 54 can all be tightly controlled to less than 2.5 μm by standard manufacturing techniques. After the precision relationships between the waveguides and PVCLs have been established through precision fixture references and vacuum forces, an adhesive can be applied to their top surfaces and the system substrate 67 attached (FIG. 12B). This ‘back side’ attachment confers the benefits of a floating bond-line that helps to absorb variations in the Z-axis component tolerance stack-up. The system substrate 67 can also be attached using different adhesive systems such as PSA tape film. Mechanical references on the vacuum chuck 54, such as the tooling pins 98, can also enable registration of the system substrate in X and Y with respect to the components, which can be useful if the system substrate includes electrically conductive elements for subsequent attachment of optical emitters and detectors (see below). After attachment of the system substrate, the assembly is removed from the vacuum fixture (FIG. 12C).

As explained in published US patent application No US 2008/0159694 A1, the waveguides and PVCLs can be designed to encompass the perimeter of a touch sensor input area in a variety of plan view configurations, including ‘straights’, ‘L-shapes’ and ‘frames’.

This disclosure offers assembly process advantages over embodiments found in the prior art by enabling the entire touch sensor optical system to be assembled on one fixture by leveraging planar component design and planar process design. In addition, the use of template-style fixtures with recesses 100 enables the construction of touch sensor optical systems with much larger PVCLs, enabling a greater variety of possible lens shapes with larger apertures. To further explain this advantageous template feature, precision Z-axis relationships between optical elements (that enable an optical axis consistent with system design and power loss requirements) can be established between component structures of varying heights by referencing critical component surfaces (datums) to common Z-axis flatness references and/or to precision machined or engineered structures on the template. Atmospheric pressure can be used through the incorporation of a vacuum apparatus to maintain precision relationships temporarily. This ‘low optical power loss’ optical axis can be established between optical components of varying sizes and shapes by engineering recesses or similar structures in the template to accommodate Z-height differences between the components. In addition, the components themselves can be engineered by design to enable mutual precision Z-axis relationships across a common Z-axis flatness reference, or through the template, vacuum table or tooling. In the context of an optical touch sensor, recessed templates enable the optical axes of waveguides to match the optical axes of much taller planar vertical collimating lenses. Because the lenses are much taller than the waveguides, they are able to capture a significant portion of light emerging from the waveguides in divergent fashion.

The fixture designs of this disclosure also enable processing based on ‘back side’ attachment of the system substrate 67 and floating bond-lines based on fixture-referenced component surfaces. The floating bond-lines enable more consistent inter-component relationships in the Z-axis with respect to fixture references. The fixtured component surfaces establish an extremely accurate optical axis for the assembled touch sensor system, because key component surfaces that are referenced to the fixture are themselves optical references for components.

Certain preferred touch sensor construction embodiments include additional mechanical structures to mechanically strengthen the touch sensor system assembly and to create an environmental enclosure to protect the system's optical components and optical surfaces from humidity, moisture, condensation, particles, dust and other contamination resulting from system use and the outside environment. Preferably, the enclosure provides a hermetic seal for the optical components. For the purposes of this disclosure these embodiments are referred to as ‘system enclosure’ embodiments. There are two basic system enclosure embodiments. The first is based on mechanical elements added to the touch sensor construction per se, independent of the touch sensor's subsequent integration into end use display devices, while the second embodiment is based on a design where additional mechanical features in the touch sensor construction combine with mechanical elements in the display device's top-case or bezel.

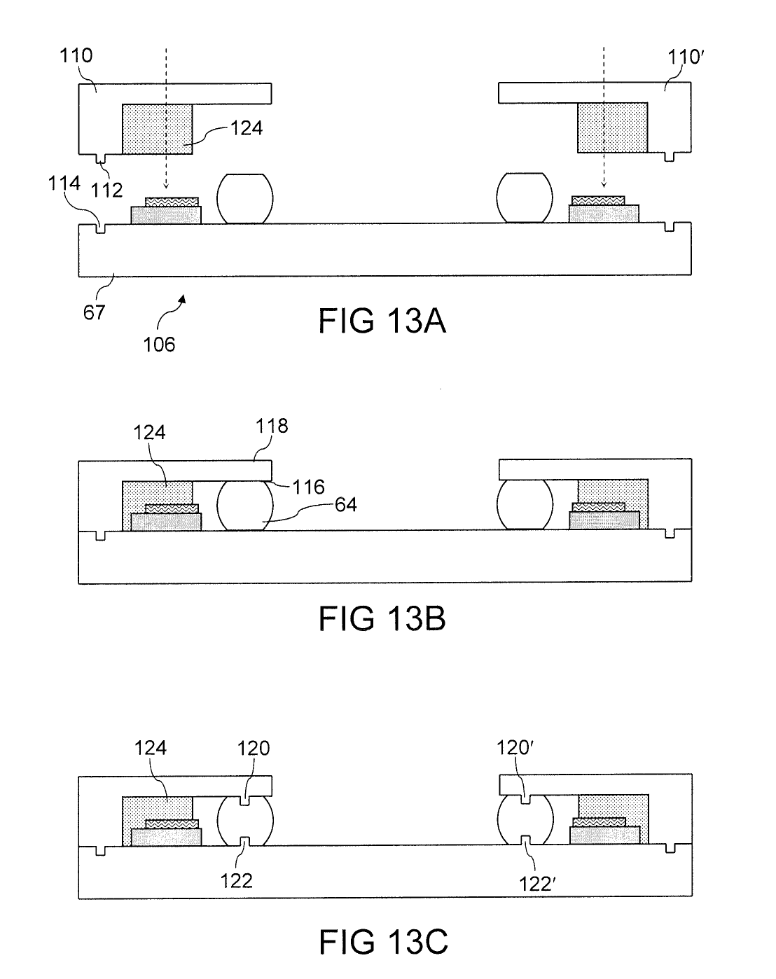

An example assembly of a first system enclosure embodiment is described with reference to FIGS. 13A, 13B and 13C. In this example a touch sensor optical construction 106 assembled for example by the processes illustrated in FIG. 9B or 12C is protected by ‘book-end’ structures 110, 110′. These ‘book-end’ structures preferably include projections 112 designed to mate with recesses 114 in the system substrate 67 to facilitate X, Y positioning of the structures and to strengthen the resulting enclosure mechanically and environmentally. These projections and recesses may also be designed for kinematic coupling. The enclosure is completed by the join 116 between the PVCL 64 and the cantilever portion 118 of the book-end, a join that can also be strengthened with mechanically coupled projections and recesses 120, 120′. As disclosed in US 2008/0159694 A1, coupled projections and recesses 122, 122′ can be used to facilitate X, Y positioning of the PVCLs on the system substrate, additionally providing increased mechanical strength for the third attachment point of the system enclosure. Irrespective of whether the attachment points are strengthened with mechanical couplings, all three attachment points are sealed with adhesives such as double-sided PSA tape or liquid adhesives. A final preferred feature of the system enclosure is compressible foam 124, composed of polyurethane for example, that molds itself around the waveguides to protect them from mechanical shock. It will be appreciated that the enclosed optical systems shown in FIGS. 13B and 13C could also include optoelectronic elements such as LEDs and camera chips.

The inside environment is a sealed mechanical enclosure that protects against the effects of moisture, particulates, contamination, and other factors from acting on the touch sensor optical system, in addition to strengthening the assembly. It is referred to as the ‘system enclosure’ in this disclosure. Construction embodiments based on this system enclosure that are enabled by the planar nature of the optical touch sensor design are described. This system enclosure can include mechanical elements from the ‘top case’ and bezel of a video display based device, and the planar vertical collimating lens design enables important embodiments of the system enclosure.

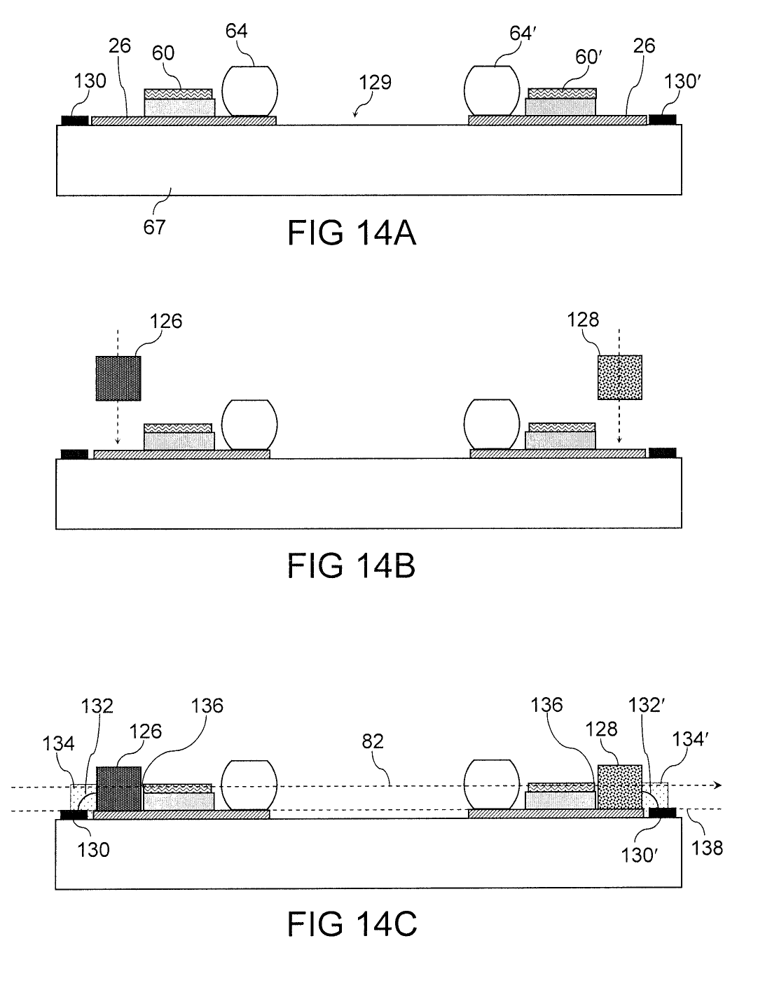

FIGS. 14A, 14B and 14C show cross-section views of an optical touch sensor assembly where the planar manufacturing principles of this disclosure are extended with the attachment of an LED 126 and a camera chip 128 to a patterned permanent PSA film 26 laminated onto a system substrate 67. The patterned PSA film includes a gap 129 for unobstructed viewing of an underlying display. Once the waveguides 60, 60′ and PVCLs 64, 64′ have been attached to the PSA film as shown in FIG. 6B for example, the LED and camera chip, packaged if required to enable ‘transverse’ attachment, are aligned and transferred to the system substrate by precision machine vision-based pick and place automation technology in accurate X, Y relation to the termini of the respective waveguide systems. The transfer robot's ‘end effecter’ releases each component in turn, and the components are then wire bonded to the bond pads 130, 130′ on the system substrate with wires 132, 132′ to complete the electrical connections. A structural adhesive 134, 134′ can be applied to strengthen the resulting assembly and help protect the bond wires, and optical adhesives (preferably index matched to the waveguide material) can be applied to the waveguide-component interfaces 136. Importantly, the planar construction methods accurately establish the optical axis 82 of the resulting touch sensor system and its relation to the basic mechanical reference 138 of the system substrate surface. The combination of machine vision-based pick and place methods and PSA surfaces can yield placement accuracy in X, Y of better than 1 μm, superior to the placement accuracy of pick and place methods based on standard surface mount technologies including epoxy stamping.

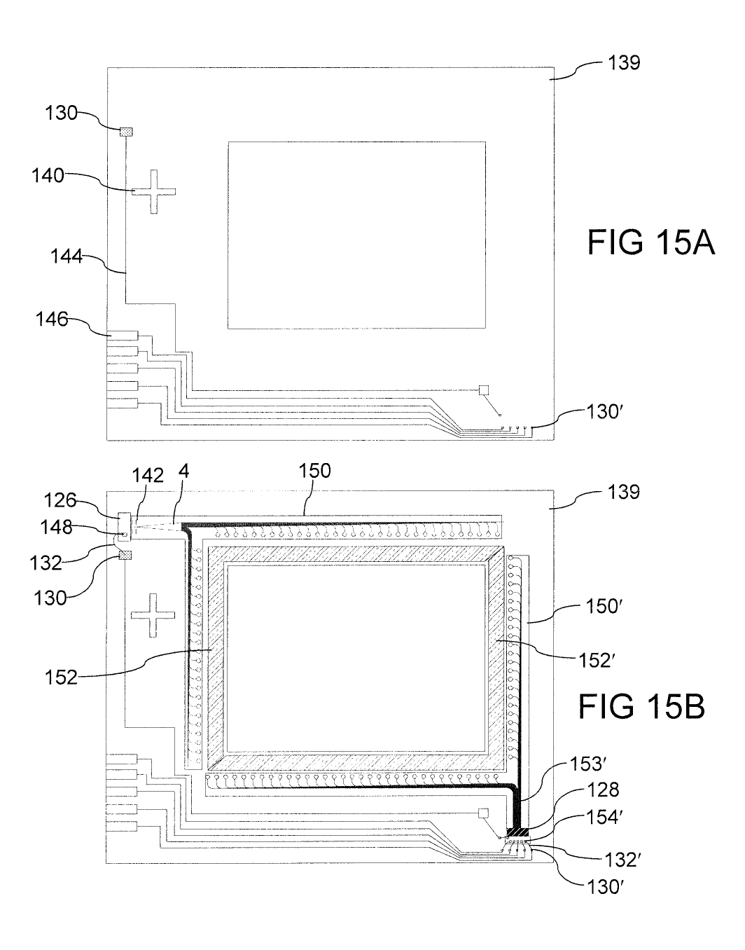

FIG. 15A shows a plan view of a ‘frame’ style system substrate 139 incorporating printed circuit board (PCB) functionality for electrical connections and optical alignment targets (OATs) 140 to aid the machine vision system on the pick and place transfer robot. Local references such as the fiducials 142 printed on the transmit waveguide substrate 150 can be used for the fine alignment of optoelectronic components 126, 128 to the waveguide termini. Specific electrically conductive structures on the illustrated system substrate 139 include a light source bond pad 130, camera chip bond pads 130′, electrical traces 144 and leads 146 that electrically connect the touch sensor system substrate to the outside world. These electrical structures on the system substrate can be fabricated using standard PCB manufacturing technologies where a sufficiently rigid prefabricated frame made of a suitable material is metallized, then coated with a dry film photopolymer patterned by photolithography, and plated with copper. Following photopolymer stripping and etch the frame's electrical structures are completed. These electrical structures can be fabricated on the surface of almost any material, including dielectric materials. More complex variants where circuit ‘inner-layers’ are constructed within the system substrate, or added as layers to the substrate's surface in secondary processes, are possible. Traditional PCBs made from FR4 materials may serve as system substrates in this disclosure, provided they are sufficiently flat. Of course continuous' system substrates that cover the display area can be used as well, provided the circuitry is confined to the peripheral regions.

A plan view of optical touch sensor components bonded to the electrically active system substrate 139 is shown in FIG. 15B. L-shaped transmit and receive waveguide substrates 150, 150′ and L-shaped transmit and receive PVCLs 152, 152′ are placed on the system substrate, then an LED chip 126 is aligned to the terminus of the transmit waveguide 1×N splitter 4 and its bond pad 148 connected to the system substrate's bond pad 130 with the wire 132. A camera chip 128 is aligned to the tail 153′ of the receive waveguides 6′ and connections made between its bond pads 154′ and the system substrate's bond pads 130′ with the wires 132′. The cross-sectional dimensions of the 1×N splitter and receive waveguide tail, including their respective substrate dimensions, must enable their end-face areas to mate smoothly with the active surfaces of the optoelectronic components without interference from wires on the optical surfaces. Waveguide thickness, waveguide substrate thickness, and chip and package dimensions can all be adjusted to achieve the required surface match between the optoelectronic components' optical surfaces and the waveguide end-faces. This disclosure offers advantages over prior art construction and manufacturing process embodiments by enabling simpler, lower cost attachment of optoelectronic components to the optical components of an optical touch sensor system using accurate, reliable manufacturing processes. In addition, the inventive embodiments enable hermetic system construction in the form of a system enclosure (FIGS. 13A to 13C).

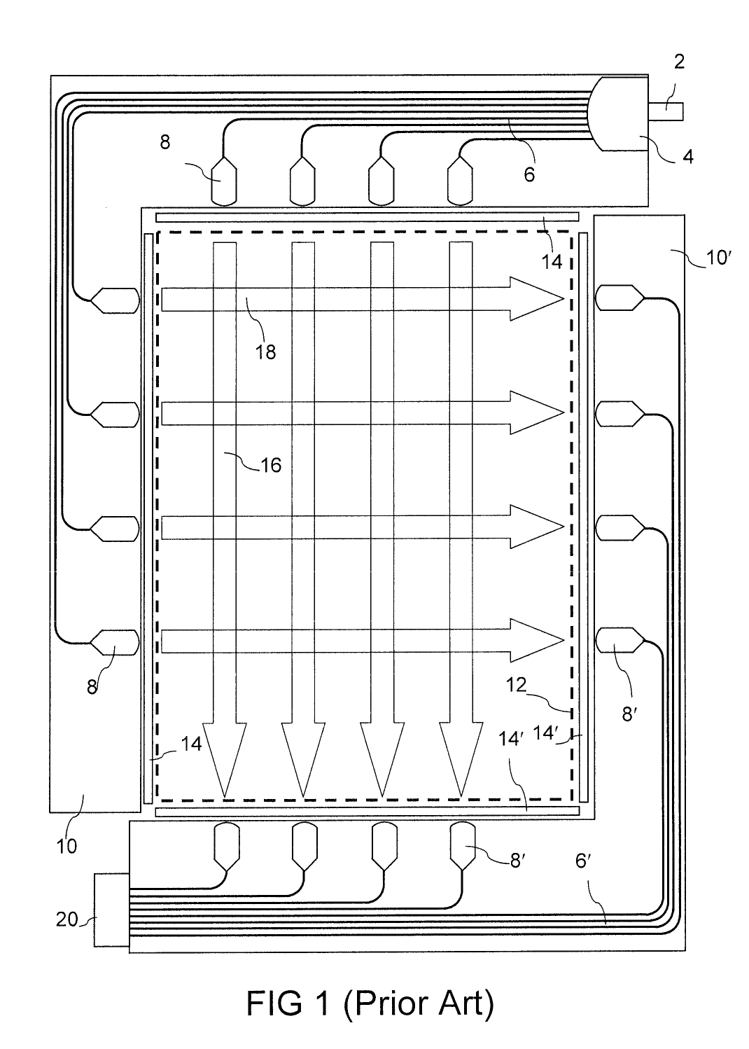

Because machine vision-based pick and place technology can deliver the touch sensor's passive optical components extremely accurately with respect to one another, and because the entire passive optical system can be assembled at one time on one surface, active alignment methods for establishing passive component alignment (as in the prior art) are not required. Those skilled in the art will understand that active optical alignment is based on sending light through an optical system to determine the best alignment of the components by monitoring system power while making small changes in component position, and locking the components in place when a power maximum is achieved. In a prior art optical touch system such as that shown in FIG. 1, the detector 20 and emitter 2 are used for active alignment of the passive optical components (transmit and receive waveguides 6, 6′ and transmit and receive VCLs 14, 14′). Those skilled in the art will also appreciate that active alignment is time consuming. In contrast, because the planar construction methods of this disclosure result in highly accurate placement and alignment of the passive optical components in X, Y and Z, active alignment is not required. As for the optoelectronic components, the CCD camera of a machine vision system is sufficient for accurate attachment of an emitter such as an LED, and for accurate attachment of relatively large area detectors such as 2D camera chips. Alternatively, once the emitter is attached it can be used to align the detector. Either way, the planar configurations and assembly processes of this disclosure require much less active alignment than prior art embodiments, thereby reducing cycle time and cost. In addition, because the passive optical components are extremely well aligned, active alignment of the emitter or detector is simplified.

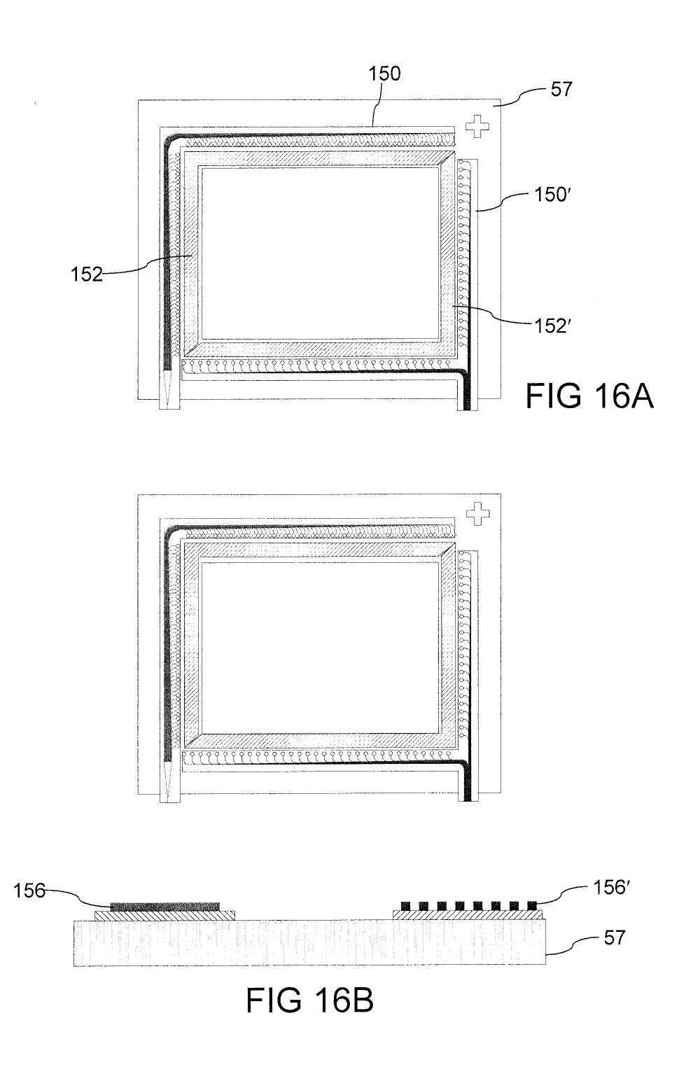

FIG. 16A shows a plan view of an assembly of passive optical touch sensor components including L-shaped transmit and receive waveguide substrates 150, 150′ and L-shaped transmit and receive PVCLs 152, 152′ on a non-electrically conductive frame-style system substrate 57. Once the waveguide substrates and PVCLs have been attached to the substrate, the optoelectronic components can be aligned to their corresponding optical waveguide end-faces 156, 156′ as shown in cross-section in FIG. 16B. The configuration shown in FIGS. 16A and 16B is also applicable to assemblies on electrically conductive system substrates. In this alternative embodiment, the optoelectronic components are electrically connected to appropriate conductive portions of the system substrate using small flex circuits formed for example from anisotropic conductive film (ACF). Irrespective of whether the system substrate is electrically conductive, this mechanical decoupling of the optoelectronic components and the system substrate by utilization of small independent flex circuits can simplify attachment processes and tooling. This mechanical decoupling can improve efficiencies in process design and create more flexibility in fitting touch sensor assemblies into the top cases of video display devices.

While only certain embodiments have been set forth, alternatives and modifications will be apparent from the above description to those skilled in the art. These and other alternatives are considered equivalents and within the spirit and scope of this disclosure and the appended claims.

What is claimed:

1. A method for assembling an optical system, said method comprising the steps of:
providing a substrate;
providing a plurality of optical elements;
arranging and selectively retaining said optical elements in a predetermined configuration; and
applying said plurality of optical elements in said predetermined configuration to said substrate, such that said optical elements are optically aligned to provide an optical path through said optical system.

2. A method according to claim 1 wherein said optical elements are selected from the group consisting of optical fibers, integrated optical waveguides, lenses, emitters, detectors, tunable gratings, beam splitters, filters, reflectors, electro-optic media and magneto-optic media.

3. A method according to claim 1 wherein said substrate comprises a substantially planar surface for defining an optical datum for said optical elements.

4. A method according to claim 3 wherein said optical path is substantially parallel to said substantially planar surface.

5. A method according to claim 3 wherein the planarity of said substantially planar surface varies by less than about 0.4 micron(μm)/cm in the X and Y directions.

6. A method according to claim 1 wherein said optical elements are optically aligned in the X and Y directions during arranging of said optical elements in said predetermined configuration.

7. A method according to claim 1 wherein said optical elements are applied simultaneously to said substrate.

8. A method according to claim 1 wherein said optical elements are applied sequentially to said substrate.

9. A method according to claim 1 wherein said optical elements are retained in said predetermined configuration on a sacrificial or temporary platform prior to being applied to said substrate, said sacrificial or temporary platform is selected from the group consisting of a vacuum table, a template, a selectively releasable adhesive sheet and combinations thereof.

10. A method according to claim 1 wherein said substrate is electrically conductive.

11. A method according to claim 10 wherein said electrically conductive substrate is a circuit board.

12. A method for assembling an optical system comprising a plurality of optical elements, said method comprising the steps of:
providing a substrate comprising a substantially planar support surface;
selectively retaining a first side of an adhesive sheet on at least a portion of said support surface; and
attaching a first surface of each of said plurality of optical elements onto a second opposite side of said adhesive sheet such that said optical elements are optically aligned to provide an optical path through said optical system.

13. A method according to claim 12 wherein said optical elements are selected from the group consisting of optical fibers, integrated optical waveguides, lenses, emitters, detectors, tunable gratings, beam splitters, filters, reflectors, electro-optic media and magneto-optic media.

14. A method according to claim 12 wherein the planarity of said adhesive sheet varies by less than 0.4 micron(μm)/cm in the X or Y directions when said adhesive sheet is retained on said support surface.

15. A method according to claim 12 comprising two adhesive sheets in the form of a stack with a release liner between them, wherein the lower adhesive sheet is selectively retained on said support surface and the upper adhesive sheet is selectively releasable from the lower adhesive sheet.

16. A method according to claim 12 comprising the step of removing said adhesive sheet from said support surface.

17. A method according to claim 12 comprising the step of selectively and releasably retaining said substrate on a manufacturing platform during assembly.

18. A method according to claim 12 wherein at least one of said optical elements comprises a positioning recess for mating with a corresponding positioning formation on said substrate, or at least one of said optical elements comprises at least one positioning formation for mating with a corresponding positioning recess on said substrate.

19. A method according to claim 12 further comprising the step of arranging and selectively retaining said optical elements in a predetermined configuration, and attaching said plurality of optical elements in said predetermined configuration to said second opposite side of said adhesive sheet.

20. An assembly for an optical system, said assembly comprising:
a substrate;
a cover plate for covering underlying optics or electronics;
a planar vertical collimating lens comprising a first surface and a second surface,
wherein said first surface is adapted for sealing engagement with said cover plate and said second surface is adapted for sealing engagement with said substrate.
